(19) United States
(12) Patent Application Publication
(10) Pub. No.: US 2007/0029784 A1
(43) Pub. Date: Feb. 8, 2007

(54) Reinforced substrate for securities

(76) Inventor: Vincent Moreau, Lausanne (CH)

Correspondence Address: David M Crompton;Crompton Seager & Tufte, 1221 Nicollet Avenue, Suite 800, Minneapolis, MN, 55403-2420, US

(21) Appl. No.: 10/526,257

(22) PCT Filed: Sep. 2, 2003
(86) PCT No.: PCT/IB03/03869

§ 371 Date: Feb. 28, 2005

(30) Foreign Application Priority Data
Sep. 10, 2002 (EP) 02405782.0

(51) Int. Cl. B42D 15/00

(52) U.S. Cl. 283/72

(57) ABSTRACT

The note (1) comprises a substrate having a zone of reduced thickness (2) forming a transparent window in said substrate and reinforcing means (3) to increase the resistance of said zone (2).

The present invention concerns a note, such as a banknote, a security note or a check, comprising a substrate having a zone of reduced thickness forming a transparent window in said substrate.

The present invention also concerns a process for treating a substrate used for forming notes, such as banknotes and securities, having a transparent zone.

In the field of banknotes and securities, there has been increasing needs for safety features protecting against counterfeiting. Indeed, in the past years, computers, scanners and copy machines have been extensively developed and today, it is possible to buy very performant devices at a reasonable price. Since these devices are more performant, it has been at the same time necessary to develop new and improved safety features for securities, such as banknotes, checks, cards (i.e. credit cards), ID cards, passports etc. which would not allow them to be copied by standard computers or scanners, or even modem color copy machines.

Such safety features include special inks, so called optical variable inks (OVI), used to print specific patterns on the substrate of the note, optical variable devices (OVD) in the shape of metallized patches or holograms, or also specific patterns, such as moire patterns and other similar patterns, all of which are very difficult if not impossible copy by actual devices, but, on the other hand, are easy to control visually.

Other safety means include combinations of superimposed lines and/or patterns with colors which are only visible under specific conditions, for example UV light or by transparency. Again, the interest of such safety means is that they may easily be printed or placed on the document to be protected and also be controlled by simple devices, even visually, but they are impossible to reproduce with actual printers, scanners or copy machines.

Another specific technique involves watermarks in which the paper substrate is marked with lines or patterns only visible in transparency. A further development of this technique concerns pseudo-watermarks consisting in the creation of a window in the substrate, especially in paper-based substrates which are normally not transparent, said window being transparent.

It is however very difficult to create or simulate a transparent window in a paper-based substrate. Transparent windows, as such, are widely used in polymer-based substrates for banknotes and securities, in order to provide a security element. These polymer based substrates are usually completely transparent, therefore, to form a transparent window, it is only necessary to leave the chosen zone free of printing. However, in the case of paper, a substrate which is not transparent, a first process has been developed according to which, it is possible to reduce locally the thickness of the paper in order to create a transparent window in the substrate. PCT application WO 99/14433 for example, discloses this process and the content of this application is incorporated by reference in the present application. According to this known process, a soaking solution is applied on at least one surface of the paper in one or several predetermined zones, then one applies pressure and heat on the soaked zone so as to evaporate and density the coated paper in said zone relative to the rest of the paper. Thus, said zones have a reduced thickness with respect to the rest of the paper and are transparent.

This first technique however has the drawback of weakening locally the paper in the zone comprising said window. In particular, the smaller the thickness of the window, the weaker the zone. Banknotes using such a technique thus have a reduced lifetime and must be exchanged, i.e. new bank notes must be printed to replace the older damaged ones.

Another technique implies to cut a hole directly in the paper in order to create the transparent window. For example, PCT application WO 95/10420, the content of which is incorporated by reference in the present application, discloses said other technique. It is of course necessary to cover the hole cut in the substrate, which is done in this case by covering the hole with a strip of transparent material, e.g. a foil or a laminate. This document specifically uses the contrast between the transparency of the window and a diffraction structure used as an additional security feature and placed inside the window. Modem copy machines and scanners are indeed unable to copy a diffraction structure and also a transparent window.

The aim of the invention is accordingly to improve the prior art.

More specifically, an object of the invention is to provide a safety feature for securities, such as banknotes, checks, ID or passports, which is very difficult to reproduce with modern printing, scanning and copying devices.

A further object of the invention is to provide a security document, such as banknotes, securities and other equivalent, comprising an improved safety feature.

The invention is defined according to the features of the claims.

An advantage of the invention is that it can be easily carried out with standard machines used in the field of producing banknotes.

Another advantage of the invention is that it provides a better support for adding further security features on the note, in particular directly on the zone with a reduced thickness, i.e. the transparent zone. One example of a safety feature which is particularly advantageous to use in the present application is disclosed in Swiss Patent application N^{o} 1661/01 filed on Sep. 7, 2001 in the name of KBA-GIORI S. A., the content of this Swiss Patent application being incorporated by reference in the present application. The safety feature for printed matter described in this application comprises a first drawing printed on one side of said printed matter, said drawing being made of a first set of geometrical shapes, and a second drawing printed on another side of the printed matter in register with a second set of geometrical shapes corresponding to the first set, but in which on of said sets comprises offset sectors so that when the recto-verso register is correct, the security feature forms zones of variable density that can be seen only in transparency.

In other words, only when the recto-verso register is correct is it possible to see the zones of variable density forming a specific shape, which has been determined by the offset sectors. The shape is usually a letter, a combination of alphanumerical characters (such as “OK”) or another geometrical shape.

The first important fact is that said offset sectors are not visible to the naked eye. Therefore, a copy machine or a scanner is not able reproduce them and a note made with a color copy machine or a scanner will not have the security feature.

The second important fact is that this security feature allows also an easy control the recto-verso register of the printing either visually or with simple optical devices. If the register is perfect or within a certain tolerance, the presence of the specific shape can be controlled. If the register is out of a certain tolerance or very bad, the specific shape will be absent of the printed matter.

In this technique, one uses mainly a set of very thin lines (with a width between 10 μm and 500 μm) spaced between 5 μm to 1000 μm. The offset sectors are thus also of this order of size. It is therefore very important that the substrate on which the lines are printed has smooth surface in order to obtain a precise printing. This is of course not the case when the substrate is made of paper and the fact that the zone in which the security element is printed is a zone of reduced thickness makes it even worse because of the fragility of said zone.

For this reason, the invention allows combinations of safety features overcoming technical difficulties and also provides a new technical result by novel features mutually supporting their technical effects. The invention also overcomes a technical prejudice according to which it was not possible to print matter on a zone of reduced thickness because of its fragility.

The invention will be better understood by the description of several embodiments with the accompanying drawings in which:

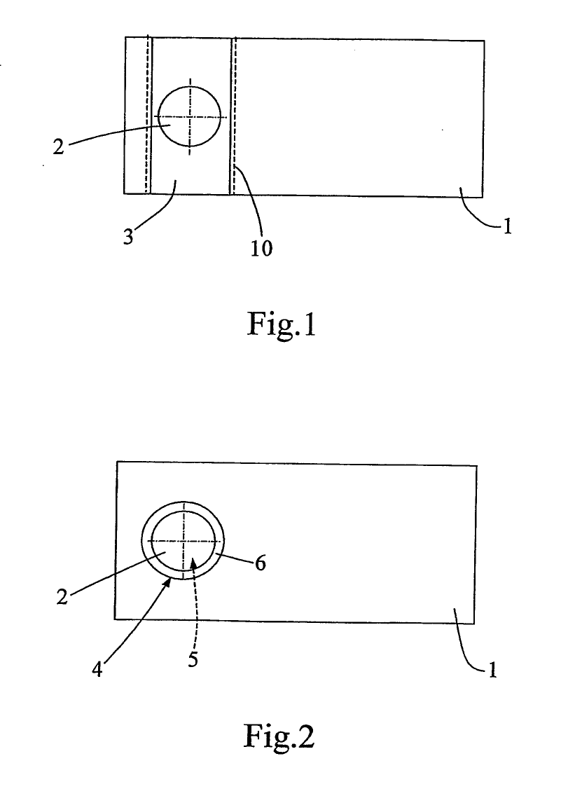

FIG. 1 shows a first embodiment of the invention.

FIG. 2 shows a second embodiment of the invention.

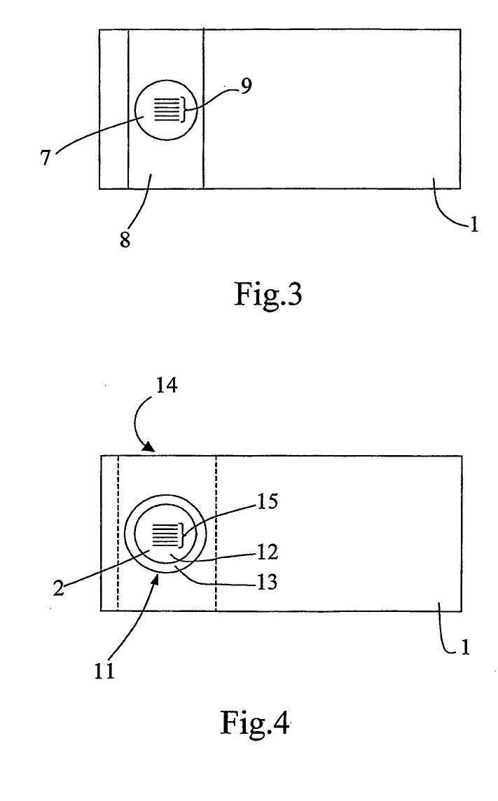

FIG. 3 shows a third embodiment of the present invention.

FIG. 4 shows a fourth embodiment of the present invention.

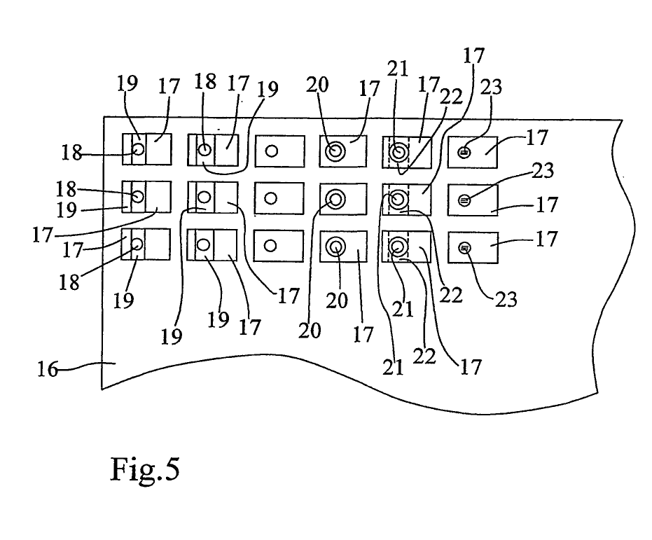

FIG. 5 shows, in a schematical manner, a sheet comprising a plurality of notes according to the invention.

A first embodiment of the invention is described with reference to FIG. 1. In this figure, a note 1, for example a banknote, is represented. Said note 1 has a given thickness and comprises a zone 2 of reduced thickness. The zone 2 is represented as a circular zone, however other shapes (square, triangular etc.) are possible. Over said zone of reduced thickness 2, a strip of transparent material 3 is placed to reinforce said zone 2. The strip of transparent material is made of an appropriate material, such as, but not limited to, Polyester (PET) or Polycarbonate (PC) films. Other materials known in the art are of course possible. The strip of material is attached to the note by conventional techniques known in the art, such as gluing or other equivalent methods known in the art.

As a variant to this embodiment, a second strip of transparent material 10 may be placed on the other side of the note 1. This second strip 10 is schematically represented in FIG. 1 by broken lines on each side of the strip 3. Of course, the second strip may be of the same size than strip 3, the broken lines being placed on each side of the strip 3 to be visible. The second strip 10 may also be smaller or larger than the strip 3.

A second embodiment is represented in FIG. 2. In this FIG. 2, as in FIG. 1, the note 1 comprises a zone 2 of reduced thickness. Over the zone 2, a patch 4, such as an OVD, has been deposited using the techniques known in the art. This patch 4 comprises a metallized layer, however, a part 5 of this layer has been demetallized, this part 5 corresponding approximately to the surface of the zone 2 of reduced thickness. The remaining surface 6 of the patch is still metallized. The strip carrying the OVD being transparent, the demetallized part 5 is also transparent whereas the remaining surface 6 reflects light. In the present embodiment, a further safety effect, impossible to reproduce with scanners and copy machines, is provided by the contrast between the transparent demetallized part 5 and the reflective part 6.

A third embodiment is represented in FIG. 3. In this figure the note 1 comprises a zone of reduced thickness 7 over which a strip 8 of transparent material has been deposited. This is similar to the embodiment represented in FIG. 1. A security element 9 is further printed on the strip 8 in the zone corresponding to the zone of reduced thickness 7 of the note. This security element is corresponds to the one described with reference to Swiss Patent application N^{o} 1661/01 mentioned above in the present specification. This security element 9 comprises a second set of lines printed on the other side of the note, but not represented here for the sake of simplicity. Reference is thus made to the entire specification of Swiss Patent application N^{o} 1661/01 incorporated in the present application for the description of the principle of said security element.

As mentioned, the reinforced substrate according to the invention is particularly suitable for use in combination with the security element 9, as described in the Swiss Patent Application N^{o} 1661/01 since the strips 3, 8, 10 and the demetallized patch 4 provide a smooth surface on which such security elements 9 may be printed.

A further embodiment of the invention is represented in FIG. 4. This embodiment combines several elements of the embodiments according to FIG. 1 to 3, and shows a note 1 comprising a zone of reduced thickness 2. Over this zone 2, a patch 11 has been attached, said patch 11 comprising a demetallized portion 12 and a metallized portion 13. This configuration is similar to the one represented in FIG. 2. Further, a strip 14 of transparent material has been applied on the other face of the note 1 with respect to the patch 11 (said strip being represented by broken lines), and a security element 15 is placed on the patch, in the demetallized zone 12 of the patch 11 which corresponds to the zone of reduced thickness 2 of the note. The safety feature is 15 is of the type using the transparency of the zone in which it has been applied, for example the principle described in Swiss Patent application N^{o} 1661/01, also used in the embodiment of FIG. 3.

This embodiment combines numerous different techniques which are all difficult, if not impossible, to reproduce with modern copy machines and scanners. It uses a substrate comprising a zone of reduced thickness, a partial optical device, a transparent window in which there is a further security element, the surface for this security element being very smooth (strip supporting the patch 11 and strip 14), thus improving the quality of the security element.

Of course, other security features/elements using the transparency of the substrate on which they are printed or applied may be used, and the embodiments described are only illustrating, by way of examples, the features of the invention.

FIG. 5 shows in a schematical manner, a sheet, for example a paper sheet, comprising several notes according to the invention. The sheet 16, only partially represented for the sake of simplicity, comprises a plurality of notes placed in successive rows and columns, as it is done in a known fashion for banknotes. Each note 17, in the two first columns, comprises a zone of reduced thickness 18, which has been produced for example according to the process disclosed in PCT application WO 99/14433 (cited above and incorporated by reference). Further, a strip of transparent material 19 has been deposited on each note 17, either on one side of the sheet 16 (embodiment of FIG. 1), or on both sides (variant to the embodiment of FIG. 1).

In the fourth column, the notes 17 have received a partially demetallized patch 20, this corresponding to the second embodiment shown in FIG. 2.

In the fifth column, the notes 17 are in the embodiment disclosed in FIG. 4 in which, on one side of the sheet 16, a partially demetallized patch 21 and on the other side of the sheet, a strip of transparent material 22 has been applied.

In the sixth column, the notes 17 have received an additional security element 23, similar to the one described here above, which can be placed in any note of the sheet, as has been described in the different embodiments of the invention.

Of course, this representation of several different embodiments is only given as an example, and normally, different embodiments of the invention would not be combined on the same sheet. Rather, depending on the complexity of the note and on the security features chosen, a particular embodiment would be selected and then all sheets would receive the proper treatment: strip on one side or both, patch on one side or both, or even in combination, with or without an additional security element as described here above.

In the present description, reference has been made mainly to banknotes, however, the principle of the invention is applicable to other similar documents (pages of passports, checks etc.) all of which comprise a non-transparent substrate in which a transparent zone has been created.

1. A note such as a banknote or security note, the note comprising a substrate having a zone of reduced thickness forming a transparent window in the substrate, wherein the note further comprises reinforcing means to increase the resistance of zone.

2. A note as claimed in claim 1, wherein the substrate is made of a paper substrate.

3. A note as claimed in claim 1, wherein the reinforcing means comprise at least a strip of material covering at least the zone of reduced thickness on at least one side of the substrate.

4. A note as claimed in claim 3, wherein the strip of material is a transparent polymer material.

5. A note as claimed in claim 1, wherein the reinforcing means comprise a patch of material covering at least the zone of reduced thickness, the patch being formed by a partially demetallized OVD patch placed on at least one side of the note.

6. A note as claimed in claim 1, wherein the reinforcing means further comprise an additional security feature.

7. A note as claimed in claim 1, wherein the reinforcing means are placed on both sides of the note.

8. A note as claimed in claim 3, wherein the reinforcing means comprise a strip on one side of the substrate and a patch on the other side of the substrate.

9. A sheet of substrate further comprising a plurality of notes as defined in claim 1.

10. A process for producing notes, such as banknotes or security notes, the notes comprising a substrate having a zone of reduced thickness forming a transparent window in the substrate, the process comprising the step of covering at least the zone on at least one side of the substrate with reinforcing means.

11. A process according to claim 10, wherein it comprises the step of covering the zone with reinforcing means on both sides of the substrate.

12. A process according to claim 10, wherein the reinforcing means comprise at least a strip or a patch of material.

13. A process according to claim 10, wherein it further comprises the step of providing said reinforcing means with an additional security feature.
